(19) United States
(12) Patent Application Publication
(10) Pub. No.: US 2009/0009742 A1
(43) Pub. Date: Jan. 8, 2009

(54) OPTICAL ELEMENT DRIVING APPARATUS, BARREL, EXPOSURE APPARATUS AND DEVICE MANUFACTURING METHOD

(76) Inventor: Yoichi Arai, Honjyo-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/118,577

(22) Filed: May 9, 2008

Related U.S. Application Data
(60) Provisional application No. 60/924,581, filed on May 21, 2007.

(30) Foreign Application Priority Data
May 11, 2007 (JP) 2007-126928

(51) Int. Cl. G02B 7/04; G02B 7/198; G03B 27/52

(52) U.S. Cl. 355/55; 359/824

(57) ABSTRACT

A permanent magnet fixed to a peripheral portion of a lens cell includes two magnets that are joined together so that the north poles face each other and the south poles are exposed. A first driving coil is arranged to face toward exits for lines of magnetic force from the joining surfaces of the north poles of the permanent magnet, and a second driving coil is arranged to face toward entrances for lines of magnetic force in the permanent magnet. The orientation of the lens is adjusted by adjusting the currents supplied to the first driving coil and second driving coil to drive the lens cell in an optical axis direction and horizontal direction in a state in which the lens cell is levitated relative to the cover.

### CROSS-REFERENCE TO RELATED APPLICATIONS

This application claims the benefit of Japanese Patent Application No. 2007-126928, filed on May 11, 2007, and U.S. Provisional Application No. 60/924,581, filed on May 21, 2007.

### BACKGROUND OF THE INVENTION

The present invention relates to an optical element driving apparatus which drives an optical element, such as a lens or a mirror. The present invention further relates to a barrel that includes at least one optical element. The present invention further relates to an exposure apparatus used when manufacturing a device, such as a semiconductor element, a liquid crystal display element, or a thin-film magnetic head, and a device manufacturing method.

Such type of an exposure apparatus has optical systems including optical elements, such as a lens and a mirror. The optical elements are held by an optical element holding unit. Among the optical systems included in an exposure apparatus, a projection optical system has adjustable optical characteristics. For example, the projection optical system includes an optical element driving apparatus which adjusts the orientation of any one of the plurality of optical elements.

Due to the increasing requirements for higher integration over these years, for example, circuit patterns for semiconductor elements have become further miniaturized. As a result, an exposure apparatus used to manufacture such semiconductor elements is required to have improved exposure accuracy and higher resolution. To reduce the manufacturing cost of semiconductor elements, the exposure apparatus is also required to improve throughput in a photolithography process. Due to these requirements, the optical characteristics of a projection optical system must be quickly adjusted.

An exposure apparatus proposed to meet all those requirements includes a lens driving apparatus that quickly adjusts the position of a lens to increase the speed for controlling the optical characteristics of the optical system. Such a lens driving apparatus is arranged, for example, between a support surface of a base table and a guide surface of a lens holding table, which holds the lens. The lens driving apparatus includes a static bearing, which supports the lens holding table on the table in a contactless manner, and three Z-linear motors, which move the lens holding table along an axis parallel to the support surface (refer to patent document 1). The lens driving apparatus quickly drives the lens since there is no mechanical loss during movement of the lens.
[Patent Publication 1] Japanese Laid-Open Patent Publication No. 10-206714

### SUMMARY OF THE INVENTION

However, each of the three Z-linear motors included in the above lens driving apparatus can move the lens only in the optical axis direction of the lens. Accordingly, the components of the optical characteristics that can be corrected are limited.

It is an object of the present invention to provide an optical element driving apparatus and a barrel that enables an optical element to be quickly driven in a plurality of directions. It is another object of the present invention to provide an exposure apparatus and a device manufacturing method that enables highly integrated devices to be efficiently manufactured with a high yield.

To achieve the above objects, the present invention employs the structures described below corresponding to the embodiments of the present invention shown in FIGS. 1 to 10.

An optical element driving apparatus of the present invention is a driving apparatus (34, 51, and 52) which drives an optical element (29) and includes a drive source (36 to 38 and 53) which generates electromagnetic force in two different directions.

The invention enables the optical element to be driven in at least two directions with electromagnetic force. Thus, the orientation of the optical element can be changed by moving the optical element in a plurality of directions without any mechanical loss in the driving force applied by the drive source.

To facilitate understanding, the present invention is described in association with reference numerals that are added in the drawings. However, it is apparent that the present invention is not limited to the illustrated embodiments.

The present invention enables the optical element to be driven in a plurality of directions and enables the optical characteristics of the optical system to be quickly corrected.

The present invention further provides a barrel or an exposure apparatus that enables the optical characteristics of the optical system to be quickly corrected.

The present invention further enables a pattern to be accurately transferred onto a substrate with high accuracy, and enables a highly integrated device to be efficiently manufactured with a high yield.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic diagram showing the structure of an exposure apparatus according to a first embodiment of the present invention;

FIG. 2 is a perspective view of a holding unit shown in FIG. 1;

FIG. 3 is a perspective view of the holding unit shown in FIG. 1 from which a cover has been removed;

FIG. 4 is a perspective view showing a lens driving unit shown in FIG. 1 from which a cover has been removed;

FIG. 5 is a cross-sectional view of the main part of the lens driving unit shown in FIG. 1;

FIG. 6 is a diagram illustrating the layout of a second driving coil shown in FIG. 1;

FIG. 7 is a cross-sectional view of the main part of a first driving unit according to a second embodiment of the present invention;

FIG. 8 is a cross-sectional view showing the main part of a second driving unit in the second embodiment;

FIG. 9 is a flowchart illustrating a device manufacturing method; and

FIG. 10 is a detailed flowchart illustrating substrate processing shown in FIG. 9 for a semiconductor device.

### DETAILED DESCRIPTION OF THE PREFERRED EMBODIMENTS

### First Embodiment

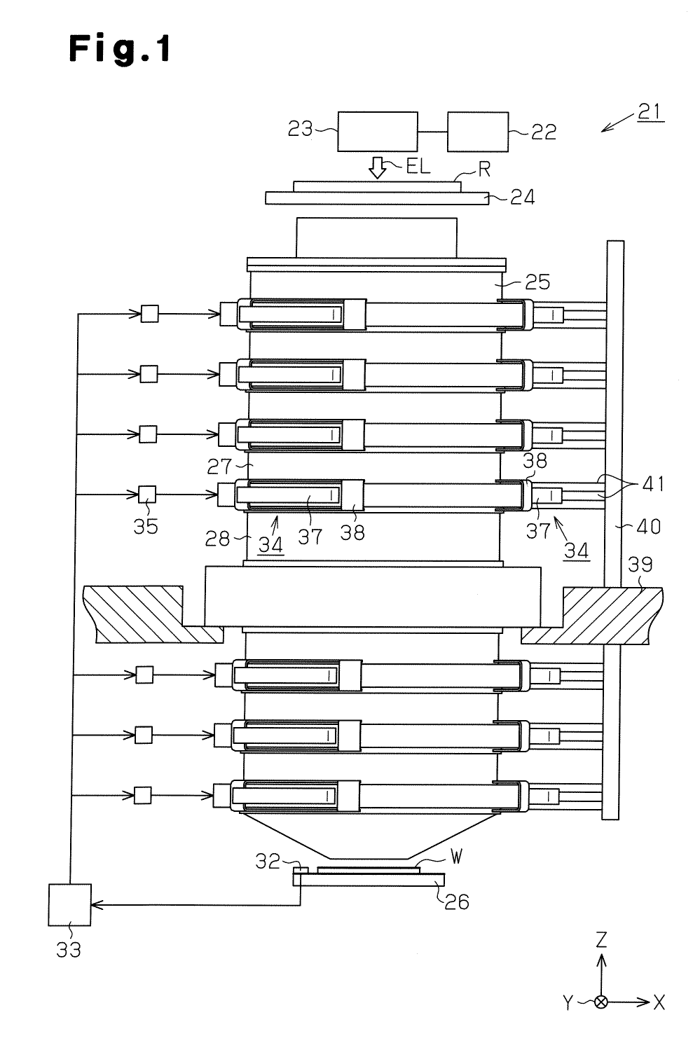

An exposure apparatus, an optical element driving apparatus, and a barrel of the present invention according to a first embodiment of the present invention will now be described with reference to FIGS. 1 to 6. The exposure apparatus, the optical element driving apparatus, and the barrel are respectively embodied in, for example, an exposure apparatus used to manufacture a semiconductor element, an optical element driving apparatus which drives an optical element, and a barrel accommodating a projection optical system.

FIG. 1 schematically shows the structure of an exposure apparatus 21. As shown in FIG. 1, the exposure apparatus 21 includes a light source 22, an illumination optical system 23, a reticle stage 24, a projection optical system 25, and a wafer stage 26. The reticle stage 24 holds a reticle R, which may be a photomask. The wafer stage 26 holds a wafer W.

The light source 22 is, for example, an ArF excimer laser light source. The illumination optical system 23 includes optical elements, an aperture stop, and the like (not shown). The optical elements may include a relay lens, an optical integrator, such as a fly's eye lens or a rod lens, and a condenser lens. Exposure light EL, which is emitted from the light source 22, passes through the illumination optical system 23. The exposure light EL uniformly illuminates a pattern formed on the reticle R.

The reticle stage 24 is arranged under the illumination optical system 23. In other words, the reticle stage 24 is arranged at an object surface side of the projection optical system 25, which will be described later. The surface of the reticle stage 24 on which the reticle R is placed is substantially orthogonal to the optical axis direction of the projection optical system 25. The reticle stage 24 is controlled to move in a predetermined scanning direction (Y direction) within a plane that extends across the optical axis direction of the projection optical system 25. In the example shown in the drawings, the optical axis direction of the projection optical system 25 extends along a Z axis.

The projection optical system 25 includes a plurality of optical elements (lenses in the present embodiment). The optical elements are accommodated in holding units 27, which are stacked together to form the barrel 28. The barrel 28 has an internal space supplied with or filled with an inert gas, such as nitrogen, helium, neon, argon, krypton, xenon, or radon.

The wafer stage 26 is arranged on an imaging surface side of the projection optical system 25. The surface of the wafer stage 26 on which the wafer W is placed extends across the optical axis direction of the projection optical system 25. The wafer stage 26 is controlled to move in two directions, that is, the scanning direction (Y direction) of the reticle stage 24 and the orthogonal direction (X direction) that is orthogonal to the scanning direction, within a plane that crosses the optical axis direction of the projection optical system 25.

The movement of the wafer W in two directions enables a plurality of shot-regions defined on the wafer W to be sequentially arranged in correspondence with an exposure field of the projection optical system 25. A pattern image formed on the reticle R is illuminated with the exposure light EL. This transfers the pattern image to the wafer W, which is supported on the wafer stage 26, through the projection optical system 25 with a predetermined reduction magnification (for example, ¼× or ⅕×). During the transfer of the pattern image, the wafer stage 26 is moved in a direction opposite to the scanning direction of the reticle stage 24 at a speed corresponding to the reduction ratio of the projection optical system 25.

Further, a wavefront aberration measurement device 32 is arranged on the wafer stage 26 to measure the wavefront aberration of the projection optical system 25. The wavefront aberration measurement device 32 provides an output signal corresponding to the measurement result of the wavefront aberration to a main control system 33, which controls each operation of the exposure apparatus 21. As will be described later, the main control system 33 controls a lens driving apparatus 34 with the use of a lens drive control system 35 based on the output signal.

The structure of the holding units 27 will now be described in detail.

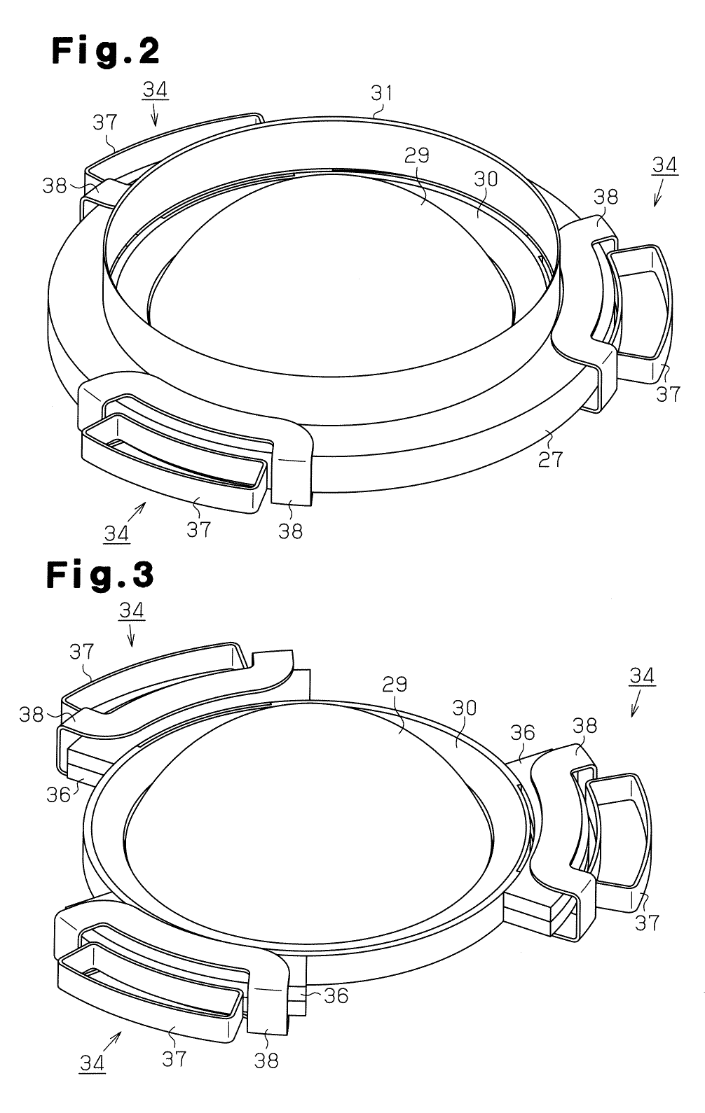

FIG. 2 is a perspective view showing one of the holding units 27. As shown in FIG. 2, the holding unit 27 includes a holding member (also referred to as a “lens cell” in the present embodiment) 30 and a cover 31. The holding member 30 holds the lens 29.

As shown in FIG. 2, the lens 29 is made of a glass material such as synthetic quartz or fluorite and has a flange extending along a peripheral portion. The lens cell 30 is formed by a metal ring. The lens 29 is attached to the lens cell 30 by a plurality of (e.g., three) flexure members (not shown) arranged at equal intervals. The flexure members hold the lens 29 by clamping the flange of the lens 29 in a direction parallel to the optical axis of the lens 29. The material forming the lens 29 and the material forming the lens cell 30 typically have different linear expansion coefficients. Thus, a difference in expansion or contraction occurs between the lens 29 and the lens cell 30 when the temperature changes during, for example, assembling, transporting, or operating the projection optical system 25. The flexure members absorb such a difference between the lens 29 and the lens cell 30. The cover 31 is made of a nonmagnetic material, such as aluminum, copper, or brass. The cover 31 separates the internal space of the barrel 28, which is defined by the holding units 27 that are stacked together, from the environment in which the barrel 28 is arranged (external space of the barrel 28). The cover 31 may also be made of nonmagnetic stainless steel.

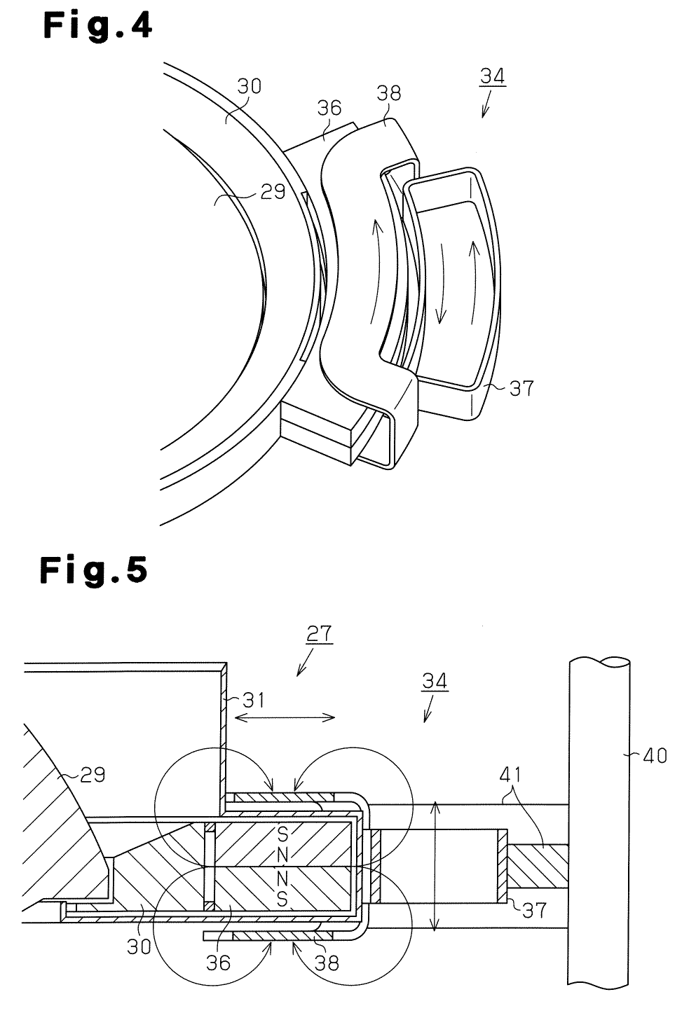

The holding unit 27 has three lens driving apparatuses 34, which are arranged at equal angular intervals about the center of the lens 29. FIG. 3 is a perspective view showing the holding unit 27 from which the cover 31 has been removed. FIG. 4 is an enlarged perspective view of the lens driving apparatus 34 from which the cover 31 has been removed. FIG. 5 is a cross-sectional view showing a portion of the holding unit 27 near the lens driving apparatus 34.

Referring to FIGS. 3 and 4, the lens driving apparatus 34 includes a first driving unit and a second driving unit. The first driving unit drives the lens 29 in a direction parallel to the optical axis of the lens 29. The second driving unit drives the lens 29 in the radial direction of the lens 29. The first driving unit includes a permanent magnet 36 and a first driving coil 37. The second driving unit includes the permanent magnet 36 and a second driving coil 38. The permanent magnet 36 is shared by the first driving unit and the second driving unit.

The permanent magnet 36 is arcuate and extends along the outer circumference of the lens 29. As shown in FIG. 5, the permanent magnet 36 is an assembly of two magnets that are joined together. The two magnets are joined in a manner that their north poles face toward each other and their south poles are exposed. The lines of magnetic force of the permanent magnet 36 extend out of the joining surfaces of the north poles of the permanent magnet 36 and curve toward the south poles of the permanent magnet 36. The permanent magnet 36 is fixed to the outer circumferential surface of the lens cell 30. Further, the permanent magnet 36 is accommodated in the cover 31.

The first driving coil 37 can be an elongated ring formed by winding a conductive wire. The first driving coil 37 is arranged in a coil opening of the second driving coil 38 and in alignment with an exit of the lines of magnetic force from the permanent magnet 36, i.e., the joining surfaces of the north poles of the two magnets in the permanent magnet 36. In the present embodiment, the permanent magnet 36 is accommodated within the cover 31, and the first driving coil 37 is arranged on the outer surface of the cover 31 at a position corresponding to the exit of the lines of magnetic force from the permanent magnet 36.

The first driving coil 37 is fixed to a support pillar 40 by a stay 41 (refer to FIG. 1). The support pillar 40 is mounted on a base 39 holding the projection optical system 25. The first driving coil 37 is arranged so that its winding wire intersects (transverses) the lines of magnetic force from the permanent magnet 36. When, for example, current is applied to the first driving coil 37 in a direction indicated by the arrows in FIG. 4, the lens driving apparatus 34 (in particular, the first driving coil 37) generates an electromagnetic force that moves the lens cell 30 upward (+Z direction) as viewed in FIG. 5 in accordance with Fleming's left hand rule.

The second driving coil 38 has two surfaces respectively facing toward the south poles, or the entrance of the lines of magnetic force, of the two magnets of the permanent magnet 36. The second driving coil 38 is formed by first preparing a generally rectangular coil and then bending the rectangular coil so as to sandwich the permanent magnet 36. In the present embodiment, the permanent magnet 36 is accommodated in the cover 31, and the second driving coil 38 is arranged outside the cover 31 at positions corresponding to the entrance of the lines of magnetic force in the permanent magnet 36. The second driving coil 38 is fixed to the support pillar 40 by the stay 41 (refer to FIG. 1). The second driving coil 38 is arranged so that its winding wire intersects the lines of magnetic force returning to the permanent magnet 36. When, for example, a current is applied to the second driving coil 38 in a direction indicated by the arrow in FIG. 4, the lens driving apparatus 34 (in particular, the second driving coil 38) generates an electromagnetic force that moves the lens cell 30 toward the center of the lens 29 in accordance with Fleming's left-hand rule.

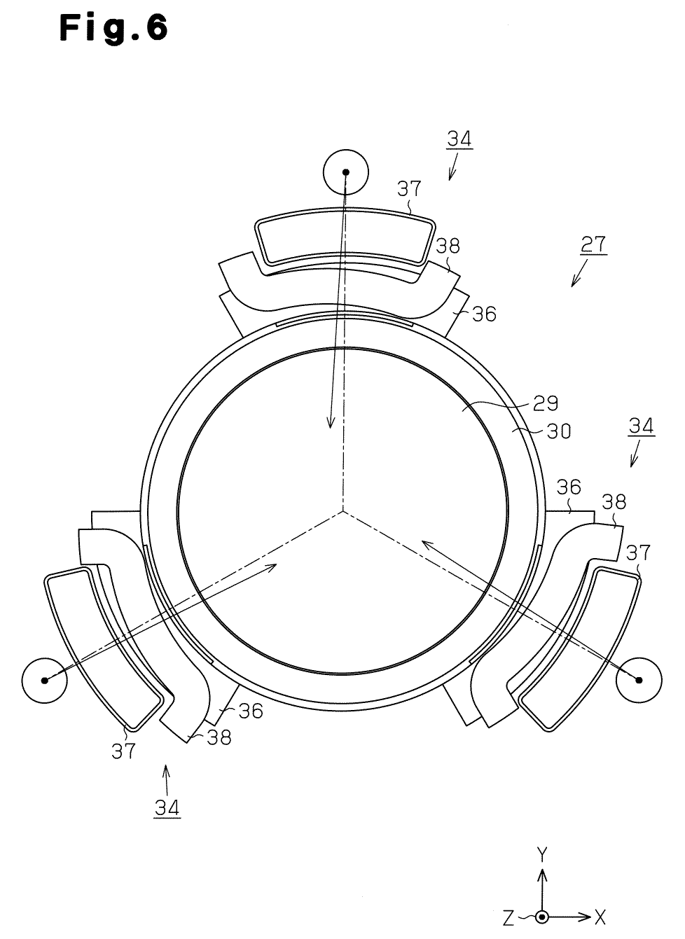

The layout of the second driving coil 38 and the permanent magnet 36 will now be described with reference to FIG. 6. As shown in FIG. 6, the second driving coil 38 is inclined at a predetermined angle as viewed from above with respect to the direction in which the permanent magnet 36 extends (the circumferential direction of the lens 29 shown in the illustrated example). To facilitate understanding, the inclination of the second driving coil 38 with respect to the permanent magnet 36 is shown in an exaggerated manner. The second driving coil 38 is actually only slightly inclined. When the second driving coil 38 is arranged in this manner, current flows through the winding wire of the second driving coil 38 in a direction that forms a predetermined angle with respect to the direction in which the permanent magnet 36 extends. In this case, magnetic interaction between the second driving coil 38 and the permanent magnet 36 produces an electromagnetic force in a direction that is slightly inclined with respect to the radial direction of the lens 29.

The electromagnetic force generated by the three lens driving apparatuses 34 arranged on the peripheral portion of the lens cell 30 levitates the lens cell 30 relative to the cover 31. As a result, the three lens driving apparatuses 34 drive the lens cell 30 in a state of non-contact with the cover 31. The lens drive control system 35 adjusts the balance (current amount ratio) and the direction of the current applied to the first driving coil 37. This enables adjustment in the movement of the lens 29 in the optical axis direction (±Z direction), movement in a direction orthogonal to the optical axis (X axis), and rotation movement of the lens 29 about the Y axis, which is orthogonal to the optical axis and the X axis. The lens drive control system 35 further adjusts the amount and the direction of the current that is applied to the second driving coils 38 of the three lens driving apparatuses 34. This enables adjustment of movement of the lens 29 in the ±y direction and ±x direction. Further, the arrangement of each second driving coil 38 in a state inclined with respect to the corresponding permanent magnet 36 enables adjustment of the rotational state of the lens 29 about the Z axis. This enables the orientation of the lens 29 to be adjusted with six degrees of freedom.

A method for correcting or adjusting the optical characteristics of the projection optical system 25 in the exposure apparatus 21 will now be described.

As shown in FIG. 1, the wafer stage 26 of the exposure apparatus 21 includes the wavefront aberration measurement device 32. The wavefront aberration measurement device 32 measures the wavefront aberration of the projection optical system 25 before a wafer W undergoes actually exposure. An example of a wavefront aberration measurement of the projection optical system 25 with the wavefront aberration measurement device 32 will now be described. First, a test reticle including a pinhole pattern is placed on the reticle stage 24. Then, the test reticle is illuminated with exposure light to generate light having spherical waves. The light enters the wavefront aberration measurement device 32 from the projection optical system 25. The light passing through the projection optical system 25 is converted into collimated light by a collimator lens. The collimated light then enters a microlens array, which includes a large number of lens laid out in a two-dimensional manner. Each lens forms an image on an imaging device according to the collimated light entering the microlens array. Then, the wavefront aberration of the projection optical system 25 is obtained based on the deviated amount of the imaging position of the image formed by each lens from a reference position (the imaging position at which an image is formed by each lens when the projection optical system 25 includes no wavefront aberration).

The main control system 33 calculates the wavefront aberration of the projection optical system 25 based on the measurement result of the wavefront aberration measurement device 32 and stores the calculated wavefront aberration in a storage unit (not shown) . When the wafer W starts to undergo actual exposure, the main control system 33 determines the present exposure position of each shot-region based on position information of the wafer stage 26. Before exposing the next shot-region, the main control system 33 calculates (predicts) changes in the wavefront aberration difference of the projection optical system 25 between the present state and when exposure of the wafer W was started. The main control system 33 then executes feed forward control to adjust the amount of current applied to the first driving coil 37 and second driving coil 38 of each lens driving apparatus 34 and correct the optical characteristics of the projection optical system 25.

The first embodiment has the advantages described below.
(1) The lens driving apparatus 34 includes the permanent magnets 36, the first driving coils 37, and the second driving coils 38. The first driving coils 37 generate electromagnetic force in the optical axis direction of the lens 29. The second driving coils 38 generate electromagnetic force in the radial direction of the lens 29.

Thus, the lens driving apparatus 34 can drive the lens 29 in the optical axis direction and the radial direction in a state levitated relative to the cover 31. The driving force produced by the lens driving apparatus 34 is used without any mechanical loss to change the orientation of the lens 29. Further, friction or the like is not produced during movement of the lens 29. Thus, the lens 29 moves quickly and accurately with an extremely high response speed of, for example, 200 Hz. Further, the lens driving apparatus 34 generates electromagnetic force in the optical axis direction and radial direction of the lens 29. This increases the directions in which the lens 29 can be moved and thereby controls the orientation of the lens 29 with a higher degree of freedom. In this manner, the optical characteristics of the projection optical system 25 are quickly and accurately corrected.
(2) In the lens driving apparatus 34, the electromagnetic force generated by the second driving coils 38 acts in the radial direction of the lens 29. This enables movement of the lens 29 within the XY plane, which intersects the optical axis of the lens 29.
(3) The holding unit 27 includes the plurality of lens driving apparatuses 34, which are arranged on the peripheral portion of the lens 29. The plurality of lens driving apparatuses 34 cooperate with one another to significantly increase the degree of freedom for controlling the orientation of the lens 29.
(4) The holding unit 27 includes the three lens driving apparatuses 34, which are arranged on the peripheral portion of the lens 29 at equal angular intervals. The holding unit 27 drives the lens 29 with six degrees of freedom. This enables the lens 29 to be controlled to any orientation. The projection optical system 25, which includes the plurality of holding units 27, easily corrects the wavefront aberration of the projection optical system 25 by controlling the orientation of each lens 29. This significantly improves the exposure performance of the exposure apparatus 21.
(5) The lens driving apparatus 34 uses the permanent magnet 36, which includes two magnets that are joined together so that the north poles face each other while the south poles are exposed. This enables the single integrated permanent magnet 36 to produce lines of magnetic force in two different directions.
(6) The lens driving apparatus 34 includes the first driving coil 37, which is arranged to extend in alignment with the exit of the lines of magnetic force from the permanent magnet 36, and the second driving coil 38, which is arranged to sandwich the two entrances of the lines of magnetic force into the permanent magnet 36. This simplifies the structure required for generating electromagnetic forces in two directions using the lines of magnetic force produced in two different directions by the permanent magnet 36.
(7) In the lens driving apparatus 34, the first driving coil 37 faces toward a portion where the north poles of two magnets face toward each other. Further, the second driving coil 38 faces toward the south poles of the two magnets. This layout prevents interference between the first driving coil 37 and the second driving coil 38 and reduces the size of the lens driving apparatus 34.
(8) In the lens driving apparatus 34, current flows through each surface of the second driving coil 38, which sandwiches the permanent magnet 36, at a predetermined angle relative to the direction in which the permanent magnet 36 extends. Thus, the second driving coil 38 generates electromagnetic force at a predetermined angle relative to the radial direction of the lens 29. The electromagnetic force generated by the second driving coil 38 rotates the lens 29 about the optical axis direction.
(9) In the lens driving apparatus 34, the permanent magnet 36 is arranged inside the cover 31, which accommodates the lens 29, and the first driving coil 37 and the second driving coil 38 are arranged outside the cover 31. This enables quick and accurate control of the orientation of the lens 29 while preventing the atmosphere inside the cover 31 (e.g., a nitrogen atmosphere) from mixing with the ambient air or reducing such mixture of the inside atmosphere with the ambient air.
(10) The holding units 27, which include the lens driving apparatus 34, are stacked together to form the barrel 28 of the projection optical system 25. Thus, the orientation of each lens 29 in the barrel 28 can be quickly adjusted with multiple degrees of freedom, and the optical characteristics of the projection optical system 25 can be quickly and accurately corrected. This improves the exposure accuracy of the exposure apparatus 21.
(11) The exposure apparatus 21 includes the lens driving apparatuses 34 which drives the lens 29 of the projection optical system 25. The projection optical system 25 forms a pattern on the wafer W. The exposure accuracy of the exposure apparatus 21 is affected by the optical performance of the projection optical system 25. With regard to this point, the projection optical system 25 can control the orientation of the lens 29 in a state in which the lens 29 is levitated relative to the cover 31, and the orientation of the lens 29 can be controlled with an extremely high response speed. As a result, the optical performance of the projection optical system 25 is quickly corrected, and the pattern transferring accuracy is further improved. This structure further enables adjustment of the focal plane of the projection optical system 25 relative to the surface position of the wafer W (surface position of the wafer W in the optical axis direction (Z direction) of the projection optical system 25). Thus, the weight of the wafer stage 26 can be greatly reduced so that the exposure apparatus 21 becomes light.

### Second Embodiment

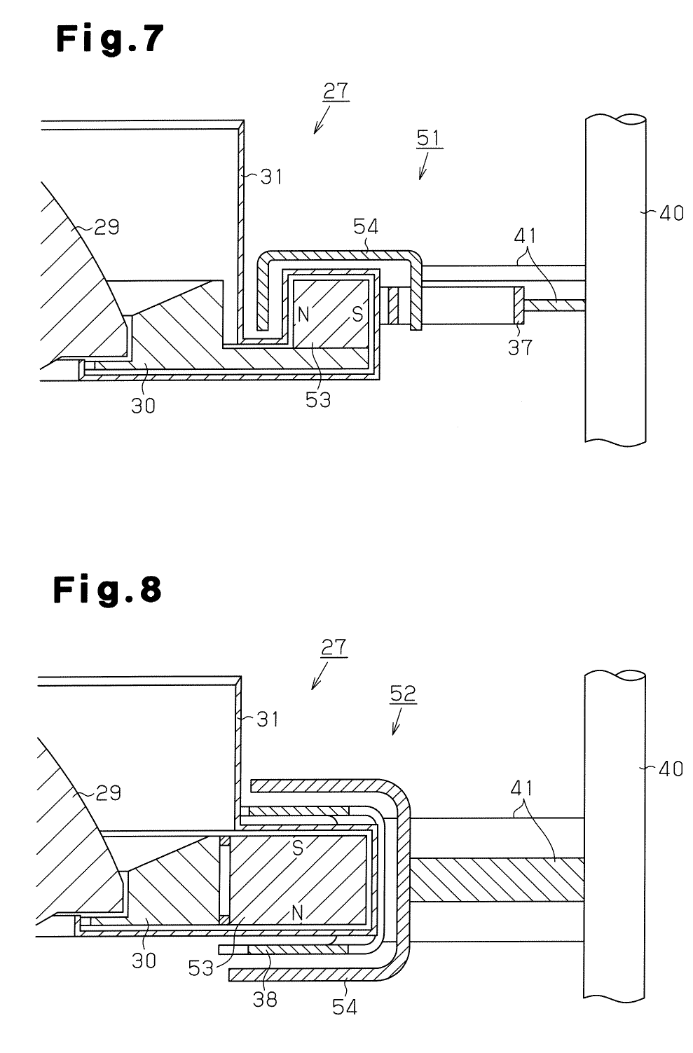

A lens driving apparatus 34 according to a second embodiment of the present invention will now be described with reference to FIGS. 7 and 8 mainly focusing on differences from the first embodiment.

As shown in FIGS. 7 and 8, the lens driving apparatus 34 of the second embodiment includes a first driving unit 51 and a second driving unit 52. The first driving unit 51 drives a lens cell 30 in the optical axis direction. The first driving unit 51 and the second driving unit 52 each include a closed magnetic field type induction motor.

As shown in FIG. 7, the first driving unit 51 includes a permanent magnet 53, which is arranged on the lens cell 30. The north pole of the permanent magnet 53 faces toward a lens 29, that is, a direction inward the lens cell 30. The south pole of the permanent magnet 53 faces a direction outward from the lens cell 30. In the same manner as in the first embodiment, the permanent magnet 53 is covered by a cover 31. A magnetic inductor 54, which has a U-shaped cross-section, is arranged outside the cover 31 so as to sandwich the north pole and south pole of the permanent magnet 53. The magnetic inductor 54 is made of a magnetic material. The magnetic inductor 54 induces lines of magnetic force from the permanent magnet 53. This produces lines of magnetic force extending from the north pole of the permanent magnet 53 to the magnetic inductor 54 and lines of magnetic force extending from the magnetic inductor 54 to the south pole of the permanent magnet 53. A first driving coil 37 is arranged between the permanent magnet 53 and the magnetic inductor 54. The first driving coil 37 has a portion that intersects (transverses) the lines of magnetic force extending from the magnetic inductor 54 to the south pole of the permanent magnet 53. When current is applied to the first driving coil 37, the first driving unit 51 drives the lens cell 30 in a direction parallel to the optical axis direction of the lens 29 in a state in which the lens cell 30 is levitated relative to the cover 31.

As shown in FIG. 8, the second driving unit 52 includes a permanent magnet 53, which is arranged on the lens cell 30. The north pole and south pole of the permanent magnet 53 are arranged in a direction parallel to the optical axis direction of the lens 29. In the same manner as in the first embodiment, the permanent magnet 53 is covered by a cover 31. A magnetic inductor 54, which has a U-shaped cross-section, is arranged outside the cover 31 so as to sandwich the north pole and south pole of the permanent magnet 53. The magnetic inductor 54 is made of a magnetic material. The magnetic inductor 54 induces lines of magnetic force from the permanent magnet 53. This produces lines of magnetic force extending from the north pole of the permanent magnet 53 to the magnetic inductor 54 and lines of magnetic force extending from the magnetic inductor 54 to the south pole of the permanent magnet 53. A second driving coil 38 is arranged between the permanent magnet 53 and the magnetic inductor 54. More specifically, the second driving coil 38 has a portion that intersects the lines of magnetic force extending from the north pole of the permanent magnet 53 to the magnetic inductor 54 and a portion that intersects (transverses) straight lines of magnetic force extending from the magnetic inductor 54 to the south pole of the permanent magnet 53. When current is applied to the second driving coil 38, the second driving unit 52 drives the lens cell 30 in the radial direction of the lens 29 in a state in which the lens cell 30 is levitated relative to the cover 31.

A plurality of the first driving units 51 are arranged on the peripheral portion of the lens cell 30 at equal angular intervals. A plurality of the second driving units 52 are arranged on the peripheral portion of the lens cell 30 at equal angular intervals between the first driving units 51.

The second embodiment has advantages that are the same as advantages (1) to (4) and (8) to (11) of the first embodiment.

The above embodiments may be modified, for example, in the following forms.

In each embodiment, the polarity of the permanent magnets 36 and 53 may be reversed.

The number of the lens driving apparatuses 34, which are attached to the peripheral portion of the lens 29, and the number of the first driving units 51 and second driving units 52 may differ from that in each embodiment.

In each embodiment, the fluid forming the atmosphere in the barrel 28 is inert gas, such as nitrogen gas. However, the fluid may be, for example, air. Alternatively, the internal space of the barrel 28 may be vacuum.

The optical element driving apparatus of the present invention is not limited to the lens driving apparatus 34 which drives the lens 29 as described in the above embodiments. The present invention is applicable to an optical element holding device that holds other optical elements, such as a mirror, a half mirror, a parallel plate, a prism, a prism mirror, a rod lens, a fly's eye lens, a phase difference plate, and a stop plate.

The optical element driving apparatus of each embodiment is applicable not only to a symmetric lens but also to an asymmetric lens or a mirror. In such a case, the direction extending from the peripheral portion of the asymmetric lens to the center of the optical axis or center of gravity of the lens is defined as the direction that intersects the optical axis direction.

In each embodiment, the optical element driving apparatuses are arranged in the holding units accommodating seven of the optical elements in the projection optical system. However, the number of the optical elements may be changed when necessary. For example, an optical element driving apparatus may be arranged in a single holding that accommodates an optical element.

The application of the optical element holding device is not limited to the projection optical system 25 of the exposure apparatus 21. For example, the optical element holding device may be applied to the illumination optical system 23 of the exposure apparatus 21. Further, the optical element holding device may be applied to an optical system of other optical machines, such a microscope or an interferometer.

The exposure apparatus does not have to include the projection optical system. The present invention may be applied to an optical system for a contact exposure apparatus, which exposes a mask pattern with a mask and substrate in contact with each other, or a proximity exposure apparatus, which exposes a mask pattern with a mask substrate located in the proximity of each other. Further, the projection optical system is not limited to a total refraction type and may be a catadioptric type or a total reflection type.

The exposure apparatus of the present invention is not limited to a reduction exposure type exposure apparatus and may be, for example, an equal magnification type exposure apparatus or an enlargement type exposure apparatus.

The present invention may be applied to an immersion-type exposure apparatus that supplies liquid between a wafer and the one of optical elements arranged closest to the wafer in a projection optical system to expose the wafer through the liquid.

The application of the present invention is not limited to an exposure apparatus adapted for manufacturing a microdevice, such as a semiconductor element. The present invention may also be applied to an exposure apparatus that transfers a circuit pattern from a mother reticle to a glass substrate, a silicon wafer, or the like for manufacturing a reticle or a mask used in a light exposure apparatus, an EUV (extreme ultraviolet) exposure apparatus, an X-ray exposure apparatus, an electron beam exposure apparatus, or the like. An exposure apparatus that uses DUV (deep ultraviolet) light or VUV (vacuum ultraviolet) light typically uses a transmissive reticle. An exposure apparatus that uses DUV light or VUV light uses a reticle substrate made of quartz glass, fluorine-doped quartz glass, fluorite, magnesium fluoride, or quartz. A proximity X-ray exposure apparatus or a proximity electron beam exposure apparatus uses a transmissive mask (a stencil mask or a membrane mask). The proximity X-ray exposure apparatus or the proximity electron beam exposure apparatus uses a silicon wafer as a mask substrate.

The present invention is applicable not only to an exposure apparatus adapted for manufacturing a semiconductor element but also to an exposure apparatus that manufactures a display including a liquid crystal display (LCD) and transfers a device pattern onto a glass plate, an exposure apparatus adapted for manufacturing a thin-film magnetic head that transfers a device pattern onto a ceramic wafer, or an exposure apparatus adapted for manufacturing an imaging device, such as a charge-coupled device (CCD).

The present invention is applicable to a scanning stepper for transferring a mask pattern onto a substrate in a state in which a mask and a substrate are moved relative to each other and sequentially step-moving the substrate. The present invention is also applicable to a step-and-repeat stepper for transferring a mask pattern onto a substrate in a state in which a mask and a substrate are still and sequentially step-moving the substrate.

Examples of the light source for the exposure apparatus include a g-line (436 nm), an i-line (365 nm), a KrF excimer laser (248 nm), an F₂ laser (157 nm), a Kr₂ laser (146 nm), or an Ar₂ laser (126 nm). Alternatively, the light source for the exposure apparatus may be a harmonic wave ultraviolet light. The harmonic ultraviolet radiation may be produced by amplifying single-wavelength laser light in an infrared region or a visible region, which is oscillated from a distributed-feedback (DFB) semiconductor laser or a fiber laser, may be amplified by a fiber amplifier doped with erbium (or both erbium and ytterbium) and converting the wavelength of the laser light using nonlinear optical crystal to harmonic wave ultraviolet light.

A manufacturing method for the exposure apparatus 21 will now be described.

First, the illumination optical system 23 and at least some of the plurality of lenses 29 or optical elements such as mirrors that form the projection optical system 25 are held on the optical system holding device, such as the lens cell 30 of the present embodiment. The illumination optical system 23 and the projection optical system 25 are then installed in the exposure apparatus 21 and optical adjustments are made. Subsequently, the wafer stage 26, which includes many mechanical parts (including the reticle stage 24 in the case of a scanning exposure apparatus), is attached and wired to the main body of the exposure apparatus 21. Wires are then connected to the exposure apparatus 21. A gas supplying pipe for supplying gas within the optical path of the exposure light EL is then connected to the exposure apparatus 21. The exposure apparatus 21 then undergoes general adjustments (including electric adjustment and operation check).

The components of the optical element holding device are subjected to, for example, ultrasonic cleaning to remove impurities including machining oil and metal substances. The components are then assembled together. The exposure apparatus 21 is preferably manufactured in a clean room in which the temperature, humidity, pressure, and cleanness are controlled.

In the above embodiments, fluorite, synthetic quartz, or the like are used as the glass material. However, the optical element holding apparatus of the above embodiments may also be applied when crystals such as lithium fluoride, magnesium fluoride, strontium fluoride, lithium-calcium-aluminum-fluoride, lithium-strontium-aluminum-fluoride, or the like; glass fluoride including zirconium-barium-lanthanum-aluminum; and modified quartz such as quartz glass doped with fluoride, quartz glass doped with hydrogen in addition to fluoride, quartz glass containing OH base, quartz glass containing OH base in addition to fluoride are used.

An embodiment of a manufacturing method for a device in which the exposure apparatus 21 described above is used in a lithography process will now be described.

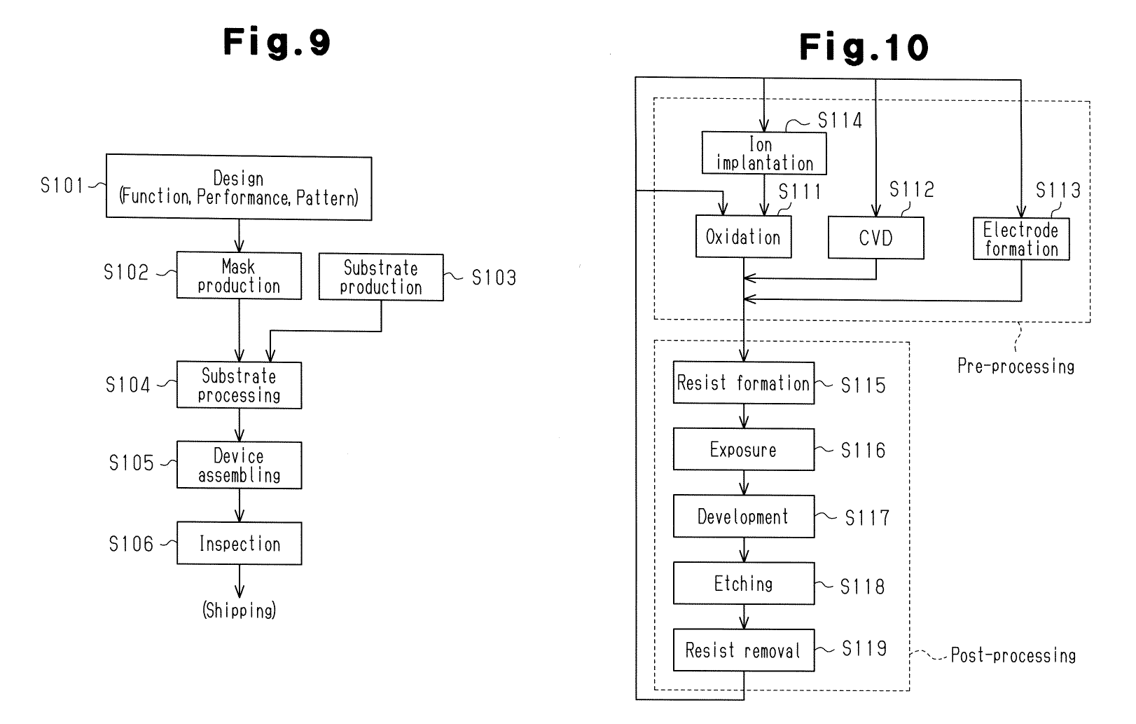

FIG. 9 is a flowchart illustrating an example for manufacturing a device (semiconductor device such as an IC and LSI, liquid crystal display device, imaging device (CCD or the like), thin-film magnetic head, micro-machine, or the like). As shown in FIG. 9, first in step S101 (design step), a function/performance design (e.g., circuit design etc. of semiconductor device) of the device (micro-device) is performed, and a pattern design for realizing the function of the device is performed. Subsequently, in step S102 (mask production step), a mask (reticle R etc.) that forms the designed circuit pattern is produced. In step S103 (substrate production step), a substrate (wafer W when silicon material is used) is produced using material such as silicon, glass plate, or the like.

In step S104 (substrate processing step), the mask and substrate prepared in steps S101 to S103 are used to form an actual circuit or the like on the substrate through a lithography technique, as will be described later. In step S105 (device assembling step), device assembly is performed using the substrate processed in step S104. Step S105 includes the necessary processes, such as dicing, bonding, and packaging (chip insertion or the like).

Finally, in step S106 (inspection step), inspections such as an operation check test, durability test, or the like are conducted on the device manufactured in step S105. Upon completion of such processes, the device is completed and the shipped out of the factory.

FIG. 10 is a flowchart showing in detail one example of the procedures performed in step S104 of FIG. 9 in the case of a semiconductor device. As shown in FIG. 10, in step S111 (oxidation step), the surface of the wafer W is oxidized. In step S112 (CVD step), an insulating film is formed on the surface of the wafer W. In step S113 (electrode formation step), an electrode is formed on the wafer W by performing vapor deposition. In step S114 (ion implantation step), ions are implanted into the wafer W. Steps S111 to S114 described above are pre-processing operations for each stage of wafer processing and are selected and performed in accordance with the processing necessary in each stage.

In each wafer processing stage, when the above-described pre-processing ends, post-processing is performed as described below. In the post-processing, first in step S115 (resist formation step), a photosensitive agent is applied to the wafer W. Subsequently, in step S116 (exposure step), the circuit pattern of a mask (reticle R) is transferred onto the wafer W by the lithography system (exposure apparatus 21), which is described above. In step S117 (development step), the exposed wafer W is developed, and in step S118 (etching step), exposed parts where there is no remaining resist are etched and removed. In step S119 (resist removal step), unnecessary resist subsequent to etching is removed.

Repetition of the pre-processing and post-processing forms multiple circuit patterns on the wafer W.

In the above-described device manufacturing method of the present embodiment, the use of the exposure apparatus 21 in the exposure process (step S116) enables the resolution to be increased due to the exposure light EL of the vacuum ultraviolet band. Further, the exposure light amount can be controlled with high accuracy. As a result, devices with a high degree of integration and having a minimum line width of about 0.1 μm are manufactured at a satisfactory yield.

The invention is not limited to the foregoing embodiments and various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined.

1 . An optical element driving apparatus which drives an optical element, the optical element driving apparatus comprising:
a drive source which generates electromagnetic force in two different directions.

2. The optical element driving apparatus according to claim 1, wherein the drive source generates electromagnetic force in an optical axis direction parallel to an optical axis of the optical element and an intersecting direction that intersects the optical axis direction.

3. The optical element driving apparatus according to claim 2, wherein the intersecting direction is a radial direction of the optical element.

4. The optical element driving apparatus according to claim 1, wherein the drive source is one of a plurality of drive sources arranged on a peripheral portion of the optical element.

5. The optical element driving apparatus according to claim 4, wherein the plurality of drive sources include three drive sources that are arranged on the peripheral portion of the optical element at substantially equal angular intervals and drive the optical element with six degrees of freedom.

6. The optical element driving apparatus according to claim 1, wherein the drive source includes a permanent magnet formed by joining two magnets so that same ones of magnetic poles of the two magnets face toward each other and the other ones of the magnetic poles of the two magnets are exposed.

7. The optical element driving apparatus according to claim 6, wherein:
the permanent magnet has an exit and an entrance for lines of magnetic force; and
the drive source further includes a first coil, which faces toward one of the exit and entrance for the lines of magnetic force of the permanent magnet, and a second coil, which faces toward the other one of the exit and entrance of the lines of magnetic force.

8. The optical element driving apparatus according to claim 7, wherein the first coil is arranged to face toward a portion at which the same ones of the magnetic poles of the two magnets face toward each other, and the second coil is arranged to face toward the other ones of the magnetic poles of the two magnets.

9. The optical element driving apparatus according to claim 8, wherein:
the permanent magnet is shaped so as to extend along a peripheral portion of the optical element; and
the second coil has two surfaces sandwiching the permanent magnet, with current flowing in each of the two surfaces in a direction that differs by a predetermined angle from a direction in which the permanent magnet extends.

10. The optical element driving apparatus according to claim 7, wherein:
the permanent magnet is arranged in a first space accommodating the optical element; and
the first and second coils are arranged in a second space that differs from the first space.

11. A barrel including a plurality of holding devices that hold a plurality of optical elements, wherein
the optical element driving apparatus according to claim 1 is arranged on at least one of the plurality of holding devices.

12. An exposure apparatus for exposing a substrate with exposure light through a plurality of optical elements, wherein:
at least one of the plurality of optical elements is driven by the optical element driving apparatus according to claim 1.

13. The exposure apparatus according to claim 12, wherein the plurality of optical elements form an optical system that forms a pattern on the substrate.

14. A method for manufacturing a device, the method comprising:
a lithography process, wherein the lithography process uses the exposure apparatus according to claim 12.
